(19) United States
(12) Patent Application Publication
(10) Pub. No.: US 2003/0077011 A1
(43) Pub. Date: Apr. 24, 2003

(54) Journal bearing

(76) Inventor: Roy A. Hall, West Palm Beach, FL (US)

Correspondence Address: Norman Friedland, Suite 400, 11300 US Highway One, North Palm Beach, FL, 33408, US

(21) Appl. No.: 10/085,827

(22) Filed: Oct. 19, 2001

(51) Int. Cl. F16C 21/00

(52) U.S. Cl. 384/126

(57) ABSTRACT

A single journal bearing replaces three bearings in applications where one arm is rotary supported by the inner diameter bearing surface of the journal bearing and another arm is rotary supported by the outer diameter of the bearing surface and the journal bearing is fixed so that it cannot rotate. In a V-shaped piston engine the female piston rod is rotary supported to the inner diameter of the journal bearing for driving the shaft crank journal affixed to the fly wheel and the male piston rod is rotary supported for articulated motion to the outer diameter of the journal bearing. In another embodiment a roller bearing is mounted withing said journal bearing and serves to rotary support the shaft crank journal of the fly wheel.

### TECHNICAL FIELD

This invention relates to journal bearings and particularly in an application for rotary machinery that requires at least two bearings and where the journal bearing will provide the function of these two bearings.

### BACKGROUND OF THE INVENTION

As one skilled in this technology appreciates, the customary bearings utilized for the piston rods and fly wheel utilized on piston engines powering motorcycles are roller bearings. One set of the roller bearings are utilized on the male connection and two sets of roller bearings are utilized on the complementary female connection. In a higher speed motorcycle that, for example, is used for racing and its speed is nearly 200 miles per hour and can accelerate to that speed in less than seven (7) seconds, the roller bearings utilized in the lower speed motorcycles are not adequate to support the load and metallic bushings are utilized and these types of bushings have not met with much success. It will be noted that the rotary speed of these engines are generally in the area of 6000 revolutions per minute and the pounds per square inch per feet per minute or PV is generally in the area of 65,000,000. Hence, it is obvious, that the load on the bearing is such that the selection of bearings used for these applications present a major problem and it is the objective of this invention to solve this problem. Moreover, as a consequence of conceiving a bearing to solve the problem for the high speed motorcycle, I have found that this invention has application for the lower speed motorcycle inasmuch as it requires fewer component parts and is less expensive than the heretofore known bearings. In the same vein, the bearings of this invention is not limited to motorcycle and combustion engine applications, it can be utilized wherever two bearings are required and the machinery can accept an inner bearing surface and an outer bearing surface of the journal bearing of this invention.

In other words, I have found that I can provide for the same application that heretofore required at least three sets of roller, ball or journal bearings, a single journal bearing where the inner diameter and outer diameter are designed to accommodate bearing surfaces. In an alternate embodiment, a roller bearing or ball bearing can be incorporated into the journal bearing so that in essence, two bearings replace the three bearings without sacrificing any function of the three bearings.

### SUMMARY OF THE INVENTION

An object of this invention is to provide an improved journal bearing design that includes working surfaces on the inner diameter and the outer diameter.

A feature of this invention is that the bifurcated end of a female piston rod and the end of the complementary male piston rod are supported by a single journal bearing with the bifurcated end being rotary supported by the inner diameter of the journal bearing and the end of the male piston rod is supported on the outer diameter by the same journal bearing and the bearing is locked in the bifurcated end.

A feature of this invention is a unique journal bearing that is characterized as being simple in design, to assemble and is relatively inexpensive. In one embodiment the material utilized is silicon nitride.

A still further feature of this invention is the incorporation of a roller or ball bearing within the journal bearing so that the inner rotating mechanism is supported by the roller or ball bearing and the outer rotating or articulating mechanism is supported by the outer diameter surface of the journal bearing.

The foregoing and other features of the present invention will become more apparent from the following description and accompanying drawings.

### BRIEF DESCRIPTION OF THE DRAWINGS

These figures merely serve to further clarify and illustrate the present invention and are not intended to limit the scope thereof

FIG. 1 is a schematic illustration of prior art reciprocating piston “V” type engine showing the piston rods connected to the fly wheel;

FIG. 2 is a fragmentary exploded plan view showing the details of this invention;

FIG. 3 is a fragmentary view in elevation showing the invention assembled;

FIG. 4 is a fragmentary bottom plan view of the assembled invention of FIG. 3;

FIG. 5 is an enlarged fragmentary sectional and plan view of FIG. 2 modified to exemplify another embodiment where a roller bearing is mounted on the inner diameter of the journal bearing so that it rotary supports the inner rotary member; and

FIG. 6 is a plan end view of FIG. 5.

### DETAILED DESCRIPTION OF THE INVENTION

While this invention is being described in its preferred embodiment for a high speed motorcycle application, as one skilled in this art will appreciate this invention has application for any type of rotary motion machine where at least two bearings are required and the inner diameter of the inventive journal bearing is one working surface and the outer diameter is another working surface and where the bearing is fixed in place. Suffice it to say that the journal bearing of this invention is fixed in place and one rotary member is rotary supported on the inner diameter of the bearing and another rotary member is rotary supported on the outer diameter of the bearing. It also should be understood that in the preferred embodiment one of the piston rods of the V-type of combustion engine rotates 360 degrees while the other piston rod operating in unison with the first piston rod articulates over a small angle. In another embodiment of this invention a roller bearing supported in a cage is mounted on the inner surface of the inside diameter of the journal bearing so that it rotary supports the inner rotating member. Obviously, as one skilled in this art will appreciate, ball bearings can be readily substituted for the roller bearings and the bearing selection will be predicated on costs and load factors.

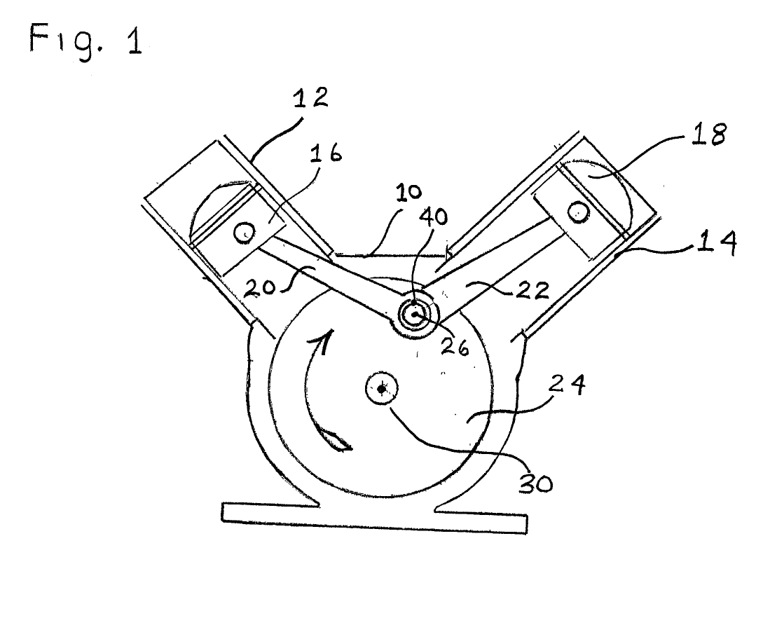

The invention can best be understood by referring to FIG. 1 which schematically illustrates a prior art V-type combustion engine generally illustrated by reference numeral 10 having a pair of angularly disposed cylinders 12 and 14 and pistons 16 and 18 respectively disposed therein. Piston rod 20 is suitably and hingedly connected to piston 16 and piston rod 22 is suitably and hingedly connected to piston 18 in any well known manner. The remote ends of piston rods are suitably connected to a pair of fly wheels where only fly wheel 24 is shown. The other fly wheel is mounted on the opposite face of the piston rod 20 and each fly wheel is connected to the piston rod 20 and piston rod 22 via the eccentric pin or shaft crank journal 26.

As is apparent from the foregoing, the piston rods when displaced drive the fly wheel in the direction of arrow A and in turn, drive the main shaft 30 for extracting power from the engine. As this invention is merely concerned with the bearings supporting the piston rods 20 and 22 to fly wheel 24, the description of the drive train for powering the motorcycle is omitted here from for the sake of brevity and convenience. Suffice it to say that the drive wheel drives either a spoke, pulley or power gear that, in turn, drives the wheel of the motorcycle.

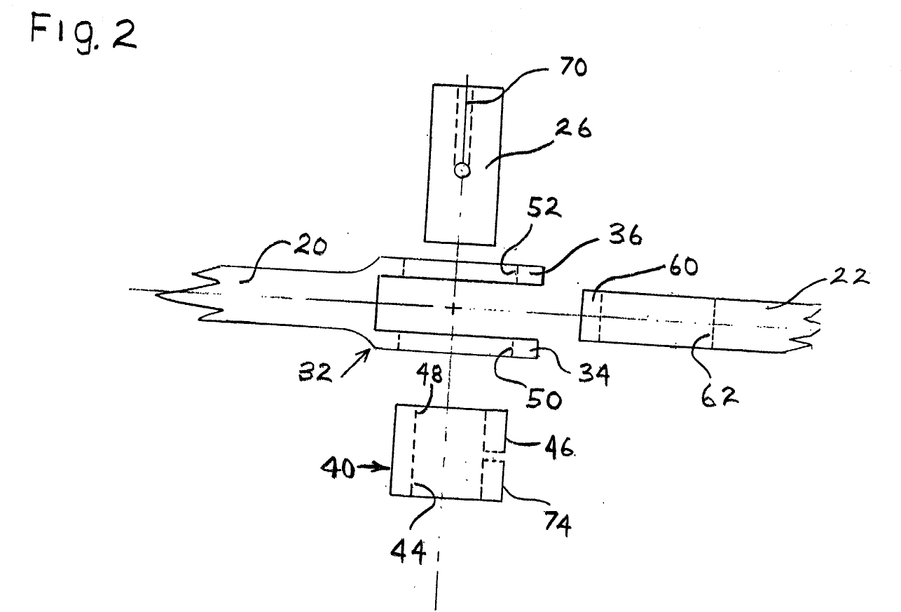

The invention can best be seen by referring to FIG. 2 which shows the piston rod 20 having a bifurcated end 32 including arms 34 and 36. The journal bearing of this invention generally illustrated by reference numeral 40 comprises a cylindrical body 42 having a central through bore 44, an outer working surface 46 on the outer diameter and an inner working surface 48 on the inner diameter. Obviously, these surfaces are suitably finished as is typical in journal bearings to accommodate the rotary motion of the rotary machine. In this embodiment as best seen through FIGS. 2 through 4, the bearing 40 is shrunk fitted into the aligned complementary bores 50 and 52 formed in arms 34 and 36, respectively, of the bifurcated end 32. The fit is done in a well known manner by heating the bifurcated end and shrinking the bearing 40 just prior to inserting the bearing into the central bore. The heat/cool ratio for the shrink fit is predicated on the end use of the rotary machine. Obviously the respective end portions 54 and 56 are rigidly secured to the inner diameter surface of the bores 50 and 52 so that the bearing can not rotate during the entire operating envelope of the engine.

The end portion 60 of male piston rod 22 includes a through bore 62 whose diameter is slightly larger than the outer diameter of the journal bearing 40 so that it can articulate about the outer surface 46 thereof. In assembling the unit the bearing 40 is first fitted into the bores of the female piston rod 20 and the male piston rod 22 is then inserted into the bifurcated portion of female piston rod 20 noting that the bore 62 aligns with the bore 44 of the bearing 40. The now assembled male piston rod 22, female piston rod 20 and journal bearing 40 are installed on the shaft crank journal 26.

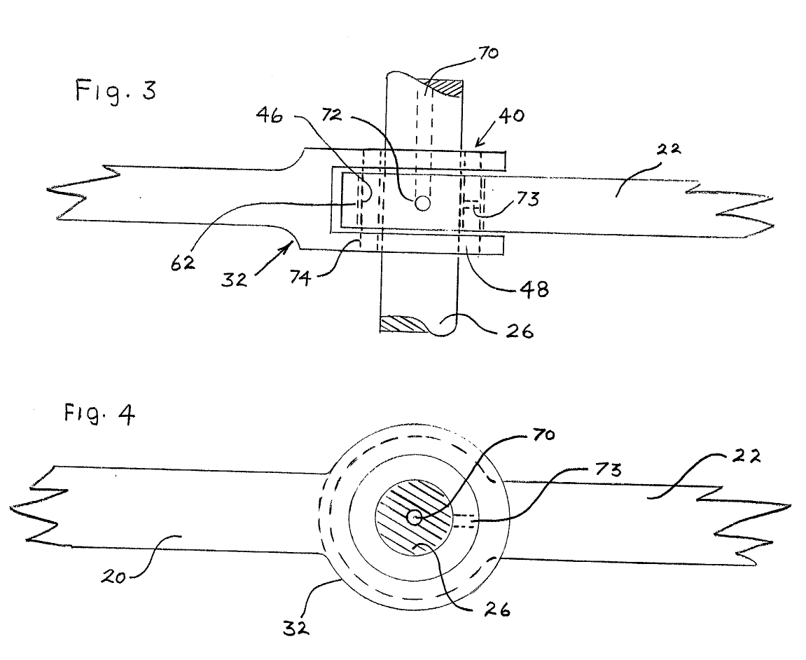

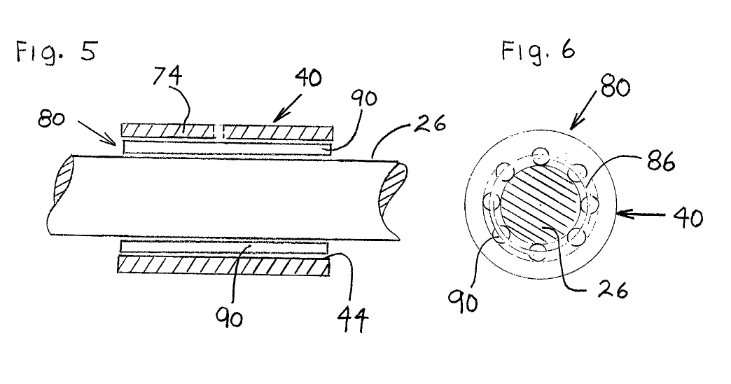

The bearing surfaces are lubricated by feeding pressurized oil into the passage 70, into drilled hole 72 formed in the shaft crank journal 26 and then, into a plurality of circumferentially spaced drilled holes 73 where the oil migrates to the bearing surfaces of the bifurcated portion 32 and the female piston rod 20 (an annular space out of proportion is shown in FIG. 3 for purposes of illustrating the bearing surface, but in actuality these surfaces are closely spaced) where the space is sufficient to define a hydrodynamic film of oil, and the bearing surface 74 intermediate the ends of journal bearing 40. The oil is pumped in a well known manner with commercially available equipment including a sump pump that collects and returns the spent oil to the pumping system for continuous flow of oil into and out of the bearing.

It is apparent from the foregoing that the shaft crank journal 26 rotates 360 degrees around the journal bearing 40 within the central bores 50 and 52 at the speed (rpm) of the fly wheel being powered by the pistons of the engine and that the male piston rod 22 articulates about the outer surface portion 74 of the journal bearing 40.

In another embodiment as is exemplified by FIG. 5, the journal bearing 40 is utilized in the same manner as the apparatus is described in connection with FIGS. 1-4 except in this embodiment a roller bearing generally illustrated by reference numeral 80 is inserted in the central bore 44 of journal bearing 40. The roller bearing comprises a commercially available suitable cage 82 having the annular end members 84 and 86 and a plurality of spaced axial rods 88, separating the rollers 90. When this embodiment is utilized in the embodiment of FIG. 2, the shaft crank journal 26 will fit inside of the roller bearing 80 and will be rotary supported thereby. In other words the rollers engage the surface on the inner diameter of the journal bearing and the shaft crank journal 26. The male piston rod will be rotary supported in the same manner as was described in connection with FIGS. 2 through 4, namely the journal bearing 40 will extend through the bores in the bifurcated section of the female piston rod and the male piston rod will be mounted over the top of the journal bearing so that the outer diameter surface of the journal bearing supports the articulating motion of the male piston rod. The shaft crank journal 26 will, obviously, be rotary supported by the rollers 90 of the roller bearing 80. As one skilled in this art will appreciate, when designing the actual hardware of a rotary machine, the type of bearing will be predicated on the loads, speeds and cost of the component parts. However, by virtue of this invention, in one embodiment, a single bearing serves the purpose of three bearings without sacrificing function and durability, and in the other embodiment two bearings serve the same purpose of the three bearings and, again without sacrificing function and durability.

By virtue of this invention the flywheel is rotary driven by the pistons in a V-shaped engine utilizing a single journal bearing 40 or a combined journal bearing and roller bearing that serve the dual function of supporting the female piston rod 20 and the male piston rod 22 and eliminating the need of three bearings that have heretofore been utilized for the same environment. In the high speed motorcycle environment the material that is preferred for the journal bearing is silicon nitride while in a lower speed motorcycle environment the material for the journal bearing can be any well known bearing material such as bronze, brass, aluminum, iron or their alloys etc.

Although this invention has been shown and described with respect to detailed embodiments thereof, it will be appreciated and understood by those skilled in the art that various changes in form and detail thereof may be made without departing from the spirit and scope of the claimed invention.

I claim:

1. A journal bearing for supporting a rotary machine having a machine element, said journal bearing having a cylindrical body and a central straight through bore, the inner diameter surface of said cylindrical body defining a first bearing surface and the outer diameter surface defining a second bearing surface and said journal bearing being fixed to said element.

2. A journal bearing for supporting a rotary machine as claimed in claim 1 wherein the journal bearing is made from silicon nitrate material.

3. A journal bearing for supporting a rotary machine as claimed in claim 1 including a female piston rod having a bifurcated end and a male piston rod having an end portion remote from the piston, said journal bearing being mounted in a straight through bore in the bifurcated end of said female piston rod and rigidly secured therein, said male piston rod having a straight through bore formed in said end portion, said journal bearing mounted in said straight through bore formed in said end portion, whereby the female piston rod is supported by the inner diameter of said journal bearing and the male piston rod is supported by the outer diameter of said journal bearing.

4. A journal bearing for supporting a rotary machine as claimed in claim 3 including lubricating system for leading oil into said straight through bore of said journal bearing and out of said journal bearing whereby oil migrates to the inner diameter of said cylindrical body and oil migrates to the outer diameter of said cylindrical body.

5. A journal bearing for a V-shaped piston engine having a pair of reciprocating pistons supported in a pair of complementary cylinders, a male piston rod attached at one end to one of said pair of reciprocating pistons, a female piston rod attached at one end to the other of said pair of reciprocating pistons, said female piston rod having a bifurcated end opposite the one end and said male piston rod having an end portion, a fly wheel having a shaft crank journal operatively connected to said male piston rod and said female piston rod, said journal bearing having a cylindrical body and a central straight through bore, the inner diameter surface of said cylindrical body defining a first bearing surface and the outer diameter surface defining a second bearing surface, said cylindrical body being mounted in a bore in said bifurcated end and rigidly affixed thereto, said shaft crank journal being rotary supported by said first bearing surface and the male rod articulating about said second bearing surface whereby when said pistons are reciprocated, said fly wheel is rotated and said shaft crank journal rotates within said cylindrical body and said male piston rod articulates over said cylindrical body.

6. A journal bearing for a V-shaped piston engine as claimed in claim 5 including a lubricating system for delivering oil into a passage formed in said shaft crank journal, into the straight through central bore of said cylindrical body and through drilled holes in said cylindrical body whereby the oil migrates to said first bearing surface and said second bearing surface.

7. A journal bearing for a V-shaped piston engine as claimed in claim 5 wherein said cylindrical body is made from silicon nitrate.

8. A journal bearing in combination with a roller bearing for supporting a rotary machine having a machine element, said journal bearing having a cylindrical body and a central straight through bore defining a cylindrical surface, a roller bearing mounted within said central bore of said cylindrical body defining a first bearing surface and the outer diameter surface of said cylindrical body defining a second bearing surface and said journal bearing being fixed to said machine element and engaging a portion of said machine element.

9. A journal bearing in combination with a roller bearing for supporting a rotary machine as claimed in claim 8 wherein said roller bearing includes a cage supporting a plurality of circumferentially spaced rollers and each of said rollers engage said cylindrical surface and engage a portion of said machine element

10. A journal bearing in combination with a roller bearing for supporting a rotary machine as claimed in claim 9 including a female piston rod having a bifurcated end and a male piston rod having an end portion remote from the piston, said journal bearing being mounted in a straight through bore in the bifurcated end of said female piston rod and rigidly secured therein, said male piston rod having a straight through bore formed in said end portion, said journal bearing mounted in said straight through bore formed in said end portion and said roller bearing mounted in said central bore of said cylindrical ?whereby the female piston rod is supported by the inner diameter of said journal bearing and the male piston rod is supported by the outer diameter of said journal bearing.

11. A combined journal bearing and roller bearing for a V-shaped piston engine having a pair of reciprocating pistons supported in a pair of complementary cylinders, a male piston rod attached at one end to one of said pair of reciprocating pistons, a female piston rod attached at one end to the other of said pair of reciprocating pistons, said female piston rod having a bifurcated end opposite the one end and said male piston rod having an end portion, a fly wheel having a shaft crank journal operatively connected to said male piston rod and said female piston rod, said journal bearing having a cylindrical body and a central straight through bore, the inner diameter surface of said cylindrical body defining a cylindrical surface and the outer diameter surface defining a bearing surface, said cylindrical body being mounted in a bore in said bifurcated end and rigidly affixed thereto, said roller bearing mounted in said central straight through bore and comprising a cage, a plurality of circumferentially spaced roller mounted in said cage, said shaft crank journal being rotary supported by said roller bearing and each of said rollers engaging said cylindrical surface and said shaft crank journal and the male rod articulating about said bearing surface whereby when said pistons are reciprocated, said fly wheel is rotated and said shaft crank journal rotates within said cylindrical body and said male piston rod articulates over said cylindrical body.
